(19) United States
(12) Patent Application Publication
(10) Pub. No.: US 2026/0169517 A1
(43) Pub. Date: Jun. 18, 2026

(54) CLOCK THROTTLER ARCHITECTURE

(71) Applicant: Arm Limited, Cambridge (GB)

(72) Inventors: Mahadevamurty NEMANI, San Diego, CA (US); Amit CHHABRA, Noida (IN); Rainer HERBERHOLZ, Great Abington (GB)

(21) Appl. No.: 18/982,328

(22) Filed: Dec. 16, 2024

(51) Int. Cl. G06F 1/08

(52) U.S. Cl. CPC G06F 1/08

(57) ABSTRACT

Clock throttler architecture including clock throttler circuitry, related methods and state machine, where the clock throttler circuitry includes: first selection circuitry to select a first pattern of a plurality of patterns in storage, where each pattern of the plurality of patterns comprises a plurality of bits; second selection circuitry to sequentially select bits of the first pattern and to provide the selected bits to clock gate circuitry in a successive manner; where the clock gate circuitry is to receive a clock input signal and to pass or gate pulses of the clock input signal responsive to applying the selected bits to generate a clock output signal.

### TECHNICAL FIELD

The present techniques relate to clock throttler architecture. In particular, the present techniques relate to clock throttler circuitry, related methods and state machine therefor.

### BACKGROUND

Some computer units (e.g. a central processor unit (CPU) or graphics processor unit (GPU)) may experience performance issues due to, for example overcurrent event(s) or overtemperature events(s).

There is a need for mitigation action to address such performance issues.

### SUMMARY

The present techniques relate to addressing or mitigating such performance issues or improving known mitigation techniques.

According to a first aspect, there is provided clock throttler circuitry for generating a clock signal, the circuitry comprising: first selection circuitry to select a first pattern of a plurality of patterns in storage, where each pattern of the plurality of patterns comprises a plurality of bits; second selection circuitry to sequentially select bits of the first pattern and to provide the selected bits to clock gate circuitry in a successive manner; where the clock gate circuitry is to receive a clock input signal and to pass or gate pulses of the clock input signal responsive to applying the selected bits to generate a clock output signal.

According to a further aspect there is provided a method of operating clock throttler circuitry to generate a clock signal, the method comprising: selecting, using first selection circuitry, a first pattern of a plurality of patterns in storage, where each pattern of the plurality of patterns comprises a plurality of bits; selecting, sequentially using second selection circuitry, bits of the first pattern responsive to a sequence of bit selection signals; providing the selected bits to clock gate circuitry in a successive manner; passing or gating, at the clock gate circuitry, pulses of the clock input signal responsive to applying the selected bits to generate a clock output signal.

According to a further aspect, there is provided a non-transitory computer readable storage medium comprising code which when implemented on a processor causes the processor to carry out the method of the previous aspect.

According to a further aspect, there is provided a system comprising: the above circuitry, implemented in at least one packaged chip; at least one system component; and a board, wherein the at least one packaged chip and the at least one system component are assembled on the board.

According to a further aspect, there is provided a chip-containing product comprising the above system assembled on a further board with at least one other product component.

According to a further aspect, there is provided a non-transitory computer-readable medium to store computer-readable code for fabrication of the above circuitry.

### BRIEF DESCRIPTION OF THE DRAWINGS

Embodiments of the present techniques will now be described by way of example only and with reference to the accompanying drawings, in which:

FIG. 1 schematically shows a block diagram of clock throttler circuitry in accordance with the present techniques;

FIG. 2a is a schematic diagram a system illustratively showing the clock throttler circuitry of the system of FIG. 1 in more detail;

FIG. 2b schematically shows an operation of a state machine of the clock throttler circuitry of FIG. 2a;

FIG. 3 schematically shows a signal diagram for the clock throttler circuitry of FIG. 2a;

FIG. 4 schematically shows example patterns in accordance with the present techniques;

FIG. 5 schematically shows a simplified flow diagram of a method of operation of the clock throttler circuitry according to one implementation of the present techniques;

FIG. 6 schematically shows a block diagram of an example system comprising the clock throttler circuitry of FIG. 1 in accordance with the present techniques; and

FIG. 7 illustrates a system and a chip-containing product in accordance with the present techniques.

### DETAILED DESCRIPTION

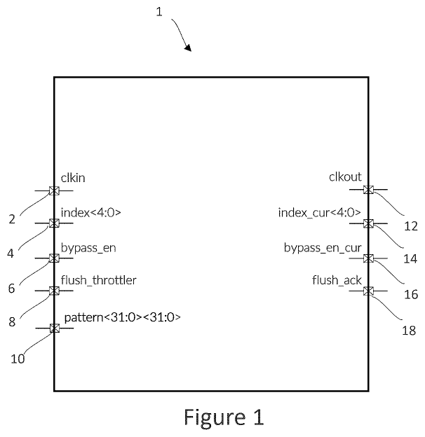

FIG. 1 schematically shows a block diagram of clock throttler circuitry 1.

The clock throttler circuitry 1 comprises various inputs and outputs to receive signals and/or to output signals (e.g. input and/or output pins or interfaces).

It will be appreciated that the term “signal” is non-limiting and may take any form to convey a message, operation or information to a component (hardware or software), where, for example, the signal may comprise one or more bits, a logic value (e.g. high or low), or a voltage value etc. In embodiments the signal may comprise a clock signal having a particular frequency and or level (e.g. voltage level).

Furthermore, the signals provided to a component (e.g. hardware or software) to control the operation thereof (E.g. to select a particular clock signal) or to change properties thereof (e.g. to cause the component to operate in a certain way) may be referred to as a “control signal.”

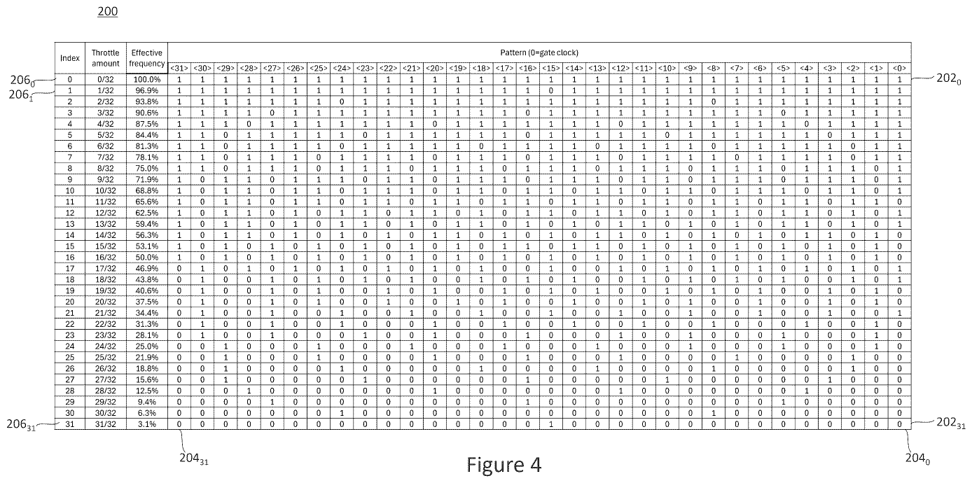

In FIG. 1, clock throttler circuitry 1 comprises:
i. Input 2 to receive clock input signal “clkin” having a plurality of clock pulses. Such a clock input signal may be from a phased locked loop clock (PLL) source and/or it may be a droop mitigated clock from a droop mitigation circuit;
ii. Input 4 to receive a pattern identifier “index” signal (depicted as 4-bit signal (index <4:0>)) in FIG. 1), where a value specified in the index signal is to identify an individual pattern of a plurality of patterns, where each pattern of the plurality comprises a plurality of bits. FIG. 4 illustratively shows examples of patterns in accordance with the present techniques.
iii. Input 6 to receive a control signal “bypass_en” to activate bypass circuitry as will be described below;
iv. Input 8 to receive a control signal “flush throttler” to indicate, when asserted, that the current pattern should be flushed or cleared;
v. Input 10 to receive a signal “pattern” comprising an n-bit pattern from storage (e.g. a register). In the present illustrative examples the pattern is a 32-bit pattern, although the claims are not limited in this respect.
vi. Output 12 to provide a clock output signal “clkout” (e.g. a throttled or gated clock signal);
vii. Output 14 comprising a signal “index_cur<4:0>” to indicate or identify the current index that is applied;
viii. Output 16 comprising a signal “bypass_en_cur” to indicate that the bypass circuitry is activated;
ix. Output 18 comprising a signal “flush_ack” to indicate when the requested flush operation to flush the current pattern is performed.

The various inputs and outputs and the operation of the clock throttler circuitry 1 are described in detail below. It will also be appreciated that additional inputs and outputs, or alternative inputs and outputs, may also be provided and the clock throttler circuitry is not limited to those depicted in FIG. 1.

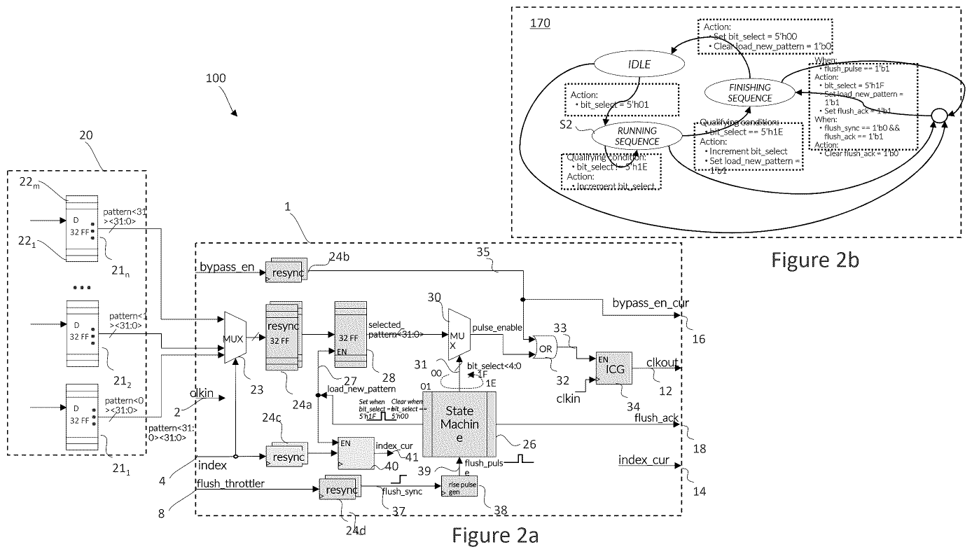

FIG. 2a is a schematic diagram a system 100 illustratively showing the clock throttler circuitry 1 in more detail. The system 100 also comprises storage 20, which in the present illustrative examples comprises a register bank comprising a plurality of n-bit registers 21₁ to 21ₙ, where each register is to store a plurality of bits 22₁ to 22ₘ. In the present illustrative example, each register is to store 32-bits, where each bit corresponds to a single bit of a 32-bit pattern as will be described in detail below. The registers may be accessed by, for example, firmware (e.g. during start-up), where the firmware may access the registers, for example, via an interface such as an Advanced Peripheral Bus (APB), which may be part of the Advanced Microcontroller Bus Architecture (AMBA) protocol family, although the claims are not limited in this respect.

While FIG. 2a depicts the storage 20 as separate from the clock throttler circuitry 1, in other embodiments the storage 20 may be integrated into the clock throttler circuitry 1.

As depicted in FIG. 2a, the clock throttler circuitry 1 receives clock input signal (clkin) at input 2. The clock input signal (clkin) may be from a phased locked loop clock (PLL) source or it may be a droop mitigated clock, although the claims are not limited in this respect.

First selection circuitry 23 (depicted as first multiplexer circuitry in FIG. 2a), selects a pattern from one of the registers 21₁ to 21ₙ responsive to the “index” signal received at input 4. The pattern defines the amount of throttle or rate (hereafter “throttle rate”) to be applied by the clock throttler circuitry. The index may be received from a state machine responsive to an event that requires clock throttling for a particular subsystem (e.g. overcurrent event; overtemperature event).

The registers 21₁ to 21n that store the respective patterns may be in a first clock domain (e.g. a relatively low frequency system clock (SYSCLK) domain) whereas at least some of the logic of the clock throttler circuitry 1 may be in a second clock domain (e.g. a relatively high frequency clock input (clkin) domain). Therefore, synchronisation circuitry 24a-d is provided to synchronise the input signals from the first clock domain to the second clock domain.

In FIG. 2a, the selected pattern is provided from the first selection circuitry 23 to synchronisation circuitry 24a, where the synchronisation circuitry 24a comprises storage depicted as a register 24a to store the bits of the selected pattern therein. Then the selected pattern in the synchronisation circuitry 24a is passed to the selected pattern register 28 responsive to a first enable signal 27 (“load_new_pattern”) received at the selected pattern register 28 from the state machine 26.

Second selection circuitry 30 (depicted as second multiplexer circuitry in FIG. 2a) selects, responsive to a particular value of “bit_select <4:0>” identifier signal 31, a particular bit of the pattern stored at the bit location/address in the selected pattern register 28 corresponding to the value of the “bit_select <4:0>” signal. The “bit_select <4:0>” signal 31 identifies a single bit location/address at the selected pattern register 28, where the state machine 26 provides bit_select <4:0> signals 31 in a successive or sequential manner. As an illustrative example, the second selection circuitry 30 will firstly select bit 0 of the pattern responsive to a first bit_select <00> signal, then select bit 1 of the stored pattern responsive to a next bit_select <01> signal, then select bit 2 of the stored pattern responsive to bit_select <02> signal and continue up to bit 31 responsive to bit_select <1F> signal, where all 32 bits are individually selected and successively passed to the logic gate 32 (i.e. responsive to an incremental sequence of bit_select <4:0> signals). Alternatively, the second selection circuitry 30 may firstly select bit 31 and then, in a decremental sequence responsive to “bit_select <4:0>” signals individually select all 32 bits, and successively pass them to the logic gate 32 (i.e. responsive to an decremental sequence of bit_select <4:0> signals). Other sequences may also be envisaged.

The second selection circuitry 30 provides the bit selected responsive to a particular bit_select <4:0> signal 31 to the logic gate 32, and the individual bits are successively provided from the logic gate 32 as a pulse enable signal 33 to integrated clock gate (ICG) circuitry 34. The logic gate 32 is depicted as an OR gate in FIG. 2a, although the claims are not limited in this respect.

The ICG circuitry 34 receives the clock input signal (clkin), which comprises a plurality of pulses, and, responsive to applying the pulse enable signal 33, passes or gates successive pulses of the clock input signal (clkin) to provide the clock output signal (clkout) 12 dependent on the value of the pulse enable signal 33 applied at the ICG circuitry. For example, the ICG circuitry 34 may pass a pulse of the clock input signal when the applied pulse enable signal is high (or 1) such that the pulse of the clock input signal (clkin) is passed and output in the clock output signal (clkout) 12. As a further example, the ICG 34 may gate a pulse of the clock input signal when the applied pulse enable signal is low (or 0) such that pulse of the clock input signal (clkin) is not output in the clock output signal (clkout). Thus, gating pulses of the clock input signal (clkin) means that the clock output signal (clkout) will have fewer pulses than the clock input signal (clkin). A clock output signal having fewer pulses than a corresponding clock input signal (clkin) is taken to be a throttled version of the clock input signal (clkin) i.e. throttled. The various patterns and signals may be used to control how the clock throttler circuitry 1ₙ throttles (i.e. the throttle rate) the clock output signal (clkout) 8₁ responsive to an event, such as an overcurrent event or an overtemperature event.

Thus, the clock throttler circuitry 1 can generate a throttled clock output signal (clkout) 8₁, which may be provided to a subsystem (e.g. CPU, GPU, NPU etc.).

The logic gate 32 also receives bypass enable signal (bypass_en) 35 to bypass the first and second selection circuitry and prevent throttling. The bypass enable signal 35 may, when asserted (e.g. set to high (or 1)), cause the ICG circuitry 34 to pass all pulses of the clock input signal (clkin) irrespective of the pulse enable signal 33, which means that all pulses of the clock input signal (clkin) will be passed and provided as the clock output signal (clkout), so the clock output signal (clkout) will not be throttled. Such bypass functionality may be provided for a test sequence or responsive to a particular user requirement.

The logic gate 32 is optional, and in an alternative embodiment, the individual bits of the selected pattern may be passed from the second selection circuitry 30 directly to the ICG circuitry 34.

As the bits of the pattern selected responsive to “bit_select <4:0>” signals are provided as the enable signal for the ICG circuitry 34, the ICG circuitry 34 passes or gates the pulses of the clock input signal (clkin) responsive to applying the bits of the pattern selected responsive to “bit_select <4:0>” signals.

In embodiments, an event (or application or user) may require a new pattern to be applied rather than waiting for the state machine to complete the cycle of “bit_select <4:0>” signals for a current pattern.

The first selection circuitry 23 may select the new pattern from one of the registers 21₁ to 21ₙ responsive to a new “index” signal received at input 4 identifying the new pattern and is provided to register 24a to store the bits of the selected new pattern.

To flush the current pattern from the selected pattern register, a “flush_throttler” signal may be asserted at input 8. The “flush_throttler” signal is synchronised to the clock input signal (clkin) clock domain at synchronisation circuitry 24d and provided as a “flush_sync” signal 37 to rise pulse generation circuitry 38. Responsive to the “flush sync” signal the rise pulse generation circuitry generates a “flush_pulse” signal 39 and provides the “flush_pulse” signal 39 to the state machine 26.

Responsive to the “flush_pulse” signal 39 being asserted (e.g. for at least one clock cycle), the state machine 26 increments the value of the bit_select signal <4:0> to correspond to a location identifying a final bit of the selected pattern to be applied (e.g. bit 32 of a 32-bit pattern) and also provides a load_new_pattern pulse. The state machine 26 also asserts (e.g. sets to 1) a flush acknowledgement signal (flush_ack) at output 18, and when the flush_sync signal is deasserted or cleared (e.g. when set to 0) the state machine deasserts or clears (e.g. sets to 0) the flush acknowledgement signal (flush_ack).

Responsive to the “load_new_pattern” pulse being asserted, a new pattern is stored at the selected pattern register 28 and the state machine 26 then clears the “load_new_pattern” signal and restarts a new sequence of “bit_select <4:0>” signals to cause second selection circuitry 30 to select individual bits of the new pattern and pass them to the ICG 34 to be applied.

Thus, the “flush throttler” signal enables a current pattern being applied to be flushed from the selected pattern register 28 and replaced with a new pattern to be applied before the current pattern completes.

Furthermore, the clock throttler circuitry 1 may provide one or more signals about the operation of the clock throttler circuitry 1 to external circuitry or processes. For example, latch circuitry 40 receives the index signal also provided to the first selection circuitry 23 and, responsive to the “load_new_pattern” pulse, generates confirmation signal 41 (“index_cur”) to confirm the pattern that is currently being applied, where the confirmation signal (index_cur) 41 is provided at output 14.

As further example, when the first and second selection circuitry of the clock throttler circuitry 1 is bypassed, a bypass currently enabled signal “bypass_en_cur” may be provided at output 16. As further example, the state machine may also provide a flush acknowledgement signal (flush_ack) at output 18.

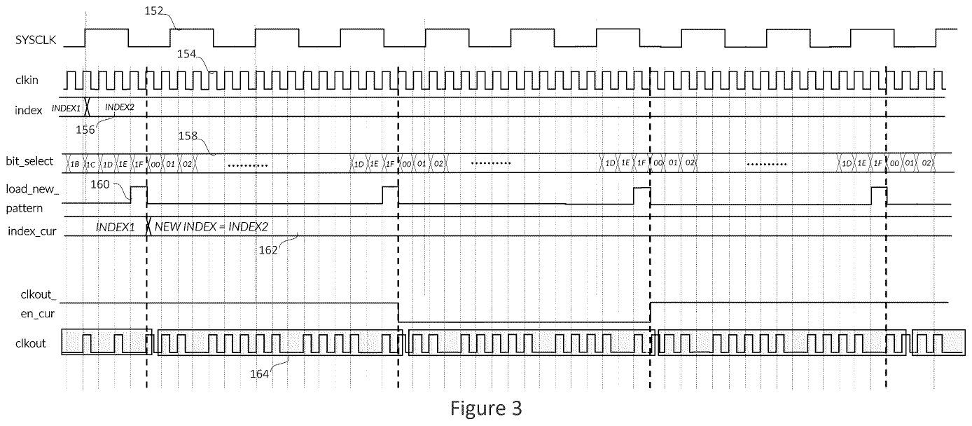

FIG. 3 schematically shows a signal diagram for the clock throttler circuitry 1 of FIG. 2a.

As depicted, system clock (SYSCLK) 152 may be a relatively low frequency clock signal compared to clock input signal (clkin) signal 154.

In operation, a pattern identifier (index <4:0>) signal 156 identifies, via an index value therein (INDEX 2 in FIG. 3), a pattern in a register of a first storage (e.g. first register bank), and causes selection circuitry to select the pattern corresponding to INDEX 2 and to pass that selected pattern to the synchronisation circuitry (e.g. a register). The selection, passing and storing of the selected pattern in the synchronisation circuitry may be performed over two clock cycles of the clock input signal 154 (clkin).

The state machine issues, e.g. responsive to a next clock input pulse a “bit_select <4:0>” signal to cause the second selection circuitry to select a particular bit at a location in the selected pattern register corresponding to that identified by the “bit_select <4:0>” signal, and to pass that particular bit to the ICG circuitry.

As depicted in the signal diagram 150, the “bit_select <4:0>” signals 158 are generated by the state machine in an increasing numerical sequence, where the sequence of “bit_select <4:0>” signals for a 32-bit pattern starts at a value corresponding to a location at the selected pattern register storing bit 0 (00) of the selected pattern and is incremented responsive to the clock input signal pulses and ends at a value corresponding to a location at the selected pattern register storing bit 31 (1F) of the selected pattern.

The state machine also asserts a “load_new_pattern” pulse 160 along with the final “bit_select <4:0>” signal in each sequence, where, responsive to the “load_new_pattern” pulse being asserted 160, the selected pattern stored at the synchronisation circuitry is passed to the selected pattern register to be stored therein. Thus, when the index value in the pattern identifier (index <4:0>) signal 156 does not change, the pattern in the selected pattern register will be reloaded into the selected pattern register. Thus the same pattern will be applied for each loop of the bit select signals until the index is replaced.

Furthermore, confirmation signal (“index_cur”) 162 is updated to confirm the pattern that is currently being applied.

The individual bits corresponding to the respective “bit_select <4:0>” signals are provided as a pulse enable signal to integrated clock gate (ICG) circuitry, where the individual pulses of the clock input signal (clkin) are passed or gated responsive to the individual bits of the pattern provided as the pulse enable signal to generate the clock output signal (clkout). Put another way, the individual pulses of the clock input signal (clkin) are passed or gated responsive to the applied pattern to generate the clock output signal (clkout).

As described above, the state machine provides the “bit_select <4:0>” signals to control selection circuitry to select individual bits at locations in a selected pattern register identified by the “bit_select <4:0>” signals. Furthermore, the state machine provides a “load_new_pattern” pulse to load a pattern into the selected pattern register.

FIG. 2b shows an example operation 170 of the state machine 26 of the clock throttler circuitry 1 depicted in FIG. 2a. The state machine 26 may be implemented as hardware and/or software. In embodiments, the state machine is implemented as fixed function hardware.

The state machine issues a bit_select signal <4:0> corresponding to a location identifying a first bit of the selected pattern to be applied (e.g. bit 0 of a 32-bit pattern) and transitions to an IDLE state.

The state machine then, as part of a running sequence, provides bit_select signals <4:0> in an incremental manner from a second bit_select signal <4:0> corresponding to a location identifying a first bit of a selected pattern to be applied up to a bit_select signal <4:0> corresponding to a location identifying a second to last bit of the selected pattern to be applied (e.g. bit 30 of a 32-bit pattern).

The state machine then, for a finishing sequence, increments the value of the bit_select signal <4:0> to correspond to a location identifying a final bit of the selected pattern to be applied (e.g. bit 31 of a 32-bit pattern) and also sets a “load_new_pattern” signal. When the finishing sequence completes, the state machine restarts the sequence and clears the “load_new_pattern” signal.

When, in the IDLE state or during the running sequence or the finishing sequence, a “flush pulse” signal is received at the state machine, then, responsive to the “flush pulse” signal being asserted (for at least one cycle) the state machine issues a bit_select signal <4:0> to correspond to a location identifying a final bit of the current pattern to be applied and also sets a “load_new_pattern” signal to cause a new pattern to be stored at the selected pattern register, and the state machine also asserts a flush acknowledgement signal (flush_ack).

When the flush_sync signal is deasserted or cleared (E.g. when set to 0) and the flush acknowledgement signal (flush_ack) is asserted (E.g. set to 1) the state machine deasserts or clears (E.g. sets it to 0) the flush acknowledgement signal (flush_ack).

FIG. 4 schematically shows an example table 200 comprising 32 rows of patterns 202₀ to 202₃₁ in accordance with the present techniques.

The patterns in FIG. 4 are depicted as 32-bit patterns, each row having 32 bits 204₀ to 204₃₁. However, the claims are not limited in this respect and patterns of other sizes may be used and the claims are not limited in a particular size of the patterns. Furthermore, when a different sized pattern is used then the size/values of the various signals required to identify that pattern (e.g. the index <X:0> signal; index_cur<Y:0> signal) and/or the individual bits in that pattern (e.g. the bit_select Z:0> signal) may also be changed accordingly.

As depicted in FIG. 4, each pattern may be identified by a corresponding pattern identifier, which in the present illustrative examples comprises an index value 206₀ to 206₃₁, where the index value may be specified in the pattern identifier (index <4:0>) signal received at the clock throttler circuitry 1.

Each bit of the respective patterns in the table of FIG. 4 has a value of 1 or 0, where when a bit having a value 1 is provided to an ICG and applied thereat, the ICG will pass a pulse of a clock signal (e.g. the clock input signal (clkin) depicted in FIG. 2a) and when a bit having a value 0 is provided to an ICG and applied thereat, the ICG will gate a pulse of a clock signal (e.g. the clock input signal (clkin) depicted in FIG. 2a), thereby throttling an effective frequency of the clock output signal.

Using the ICG to throttle the clock input signal does not affect the minimum width of the clock pulses or the minimum clock period of the pulses. Rather it is the effective frequency of the clock output signal that is throttled, where one or more pulses in the clock input signal may be gated responsive to bits in a pattern to reduce the number of corresponding pulses in the clock output signal over the length of the clock input signal to which the pattern was applied.

Thus throttling the effective frequency of a clock output signal rather than throttling the actual frequency of the clock output signal may address an event but may not impact/affect any timing-related signoff checks performed using that clock output signal.

Applying a 32-bit pattern of all 1s (i.e. the pattern at index 0 (206₀)) will result in the ICG passing all of the clock input signals responsive to pattern corresponding to index 0. Thus, applying pattern 0 will not have any throttle effect on the clock input signal.

Applying the 32-bit pattern at index 1 (206₁) will result in the ICG passing all but one of the clock input signals responsive to pattern at index 1 (206₁). Thus, applying the pattern at index 1 (206₁) will throttle the clock input signal to the ICG by approximately 3.1% to provide an effective frequency of 96.9% for the resulting clock output signal.

Similarly, applying the 32-bit pattern at index 31 (206₃₁) will result in the ICG gating all but one of the clock input signals responsive to pattern at index 31 (206₃₁). Thus, applying the pattern at index 31 (206₃₁) will throttle the clock input signal to the ICG by approximately 96.9% to provide an effective frequency of 3.1% for the resulting clock output signal.

Thus, gating a clock input signal responsive to a single bit of a 32 bit pattern will have a throttle rate of ˜3.1% on the effective frequency of the resulting clock output signal, and each additional bit will increase the throttle rate by ˜3.1% on the effective frequency of the resulting clock output signal.

Different patterns can be applied consecutively to achieve different throttle rates. For example, for the 32-bit pattern depicted in FIG. 4, applying index 1 followed by index 2 will provide a throttle rate of approximately 4.6% on the effective frequency of the resulting clock output signal.

It will be appreciated that the clock speed is not throttled when gating one or more pulses, rather it is the effective frequency that is throttled.

As depicted in FIG. 4 the zeros (0's) are distributed equally in each of the patterns. However the claims are not limited in this respect and different positions of the 1's and 0's can be used for each pattern. Taking the pattern at index 16 as an example, rather than having a sequence of 1, 0, 1, 0 . . . to provide a throttling rate of approximately 50% on the effective frequency, the pattern may be modified to have a pattern of sixteen bits each with a value of 1 followed by sixteen bits each with a value of 0. In a further example, a pattern of 100110100110 . . . may be used to provide the same throttle rate on the effective frequency (i.e. approximately 50%).

In an illustrative example, a particular pattern of 1s and 0's may, when applied, affect performance of the system (e.g. a pattern may ignite resonance frequencies in a power distribution network). Thus, the 1s and 0's in a particular pattern may be adjusted/programmed (e.g. via firmware) to avoid any negative effects as required.

Looking again at FIG. 2a, the first selection circuitry 23 is to select a pattern along a particular row 202₀ to 202₃₁ responsive to the pattern identifier (index <4:0>) signal, while the second selection circuitry 30 is to select individual bits along the columns 204₀ to 204₃₁ of the selected pattern responsive to the sequence of bit_select <4:0> signals from the state machine 26.

As set out above, the patterns are not limited to 32-bit patterns. When a 64-bit pattern is used, gating an clock input signal responsive to a single bit of a 64 bit pattern will have a throttle rate of ˜1.55% on the effective frequency of the resulting clock output signal, and each additional bit will increase the throttle rate on the effective frequency of the resulting clock output signal by ˜1.55%.

Therefore, the clock throttler circuitry can throttle the clock output signal to respond to one or more events, providing different levels of throttling as required.

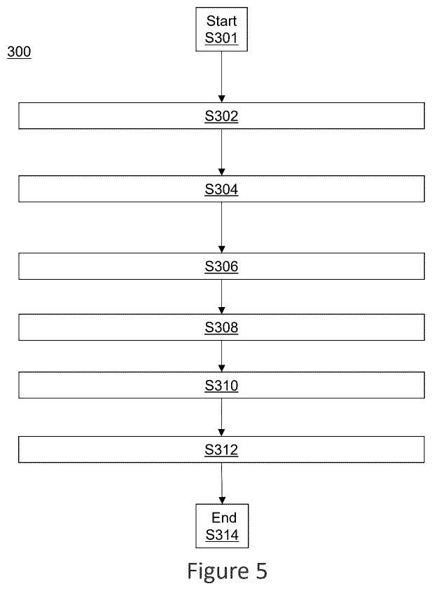

Turning now to FIG. 5, there is shown a simplified flow diagram of a method 300 of operation clock throttler circuitry according to one implementation of the present techniques.

An instance of the method starts at 301.

At S302 the clock throttler circuitry receives a pattern identifier (index <4:0>) signal specifying a value to identify a pattern to be applied to an ICG. In normal operation, when no event is detected and no throttling is required then pattern identifier (index <4:0>) may specify a value to identify a pattern signal, which, when applied, does not result in gating of the clock input signal (e.g. a signal with all 1's). When an event is detected in the system (e.g. an overcurrent or overtemperature event), then the value in pattern identifier (index <4:0>) signal may identify a pattern dependent on the throttling required to respond to the event, for example, based on the severity of the event.

At S304 a pattern is, using first selection circuitry (e.g. a multiplexer) selected from first storge (e.g. a register) responsive to the pattern identifier (index <4:0>) signal.

At S306, the selected pattern may be synchronized for the clock domain of the clock input signal.

At S308, the selected pattern is, responsive to a load signal (e.g. “a load_new_pattern” signal) from a state machine, stored in second storage (e.g. a register) at the clock throttler circuitry.

At S310, an individual bit of the selected pattern is, using second selection circuitry (e.g. a second multiplexer), selected responsive to successive bit_select signals <4:0> (e.g. provided by the state machine) and passed to the ICG. In the present illustrative example, the state machine provides a sequence of bit_select signals <4:0> each bit_select signal <4:0> in the sequence having a different value from the others, where a bit_select signal <4:0> of the sequence is provided every clock cycle until all bit_select signal <4:0> of the sequence are provided (i.e. such that all bits of the selected pattern are passed to the ICG). As described above, in some embodiments, a user can interrupt a sequence and cause the clock throttler circuitry to select a new pattern before the current completes by issuing a command signal (e.g. a flush throttler signal).

At S312, the ICG passes or gates a pulse of the clock input signal responsive to the value of a selected bit to provide a clock output signal, where the effective frequency of the clock output signal is dependent on the selected pattern applied to the ICG. A selected pattern that results in more pulses being gated will have a higher throttling effect on the effective frequency of the clock output signal compared to a selected pattern that results in more pulses being passed.

At S314, the method ends.

Thus the present techniques provide clock throttler circuitry which can throttle the effective frequency of the clock signal in steps increasing or decreasing steps. The throttled clock signal can be provided to an integrated circuit subsystem (e.g. a CPU or GPU).

One or more clock throttler circuits may be provided in a data processer system, where such a data processor system may include one or more subsystems.

For example, a data processor unit may have multiple CPU tiles where one or more clock throttler circuits may be provided inside each CPU tile. The functionality can be used to independently control the clock signals supplied to each CPU tile or to each core within a CPU tile.

In an illustrative example, a CPU may comprise a first core running a thread at a high priority from a software perspective (high priority core) and another core running a thread at a lower priority (low priority core). Thus, a pattern of all 1's may be selected and applied to the clock signal provided to the high priority core and a pattern with one or more zeros may be selected and applied to the clock signal of the low priority core to throttle the effective frequency thereof. In this way the data processing system can use one or more clock throttler circuits to provide clock signals having different effective frequencies to different cores, for example, to generate less heat in the system.

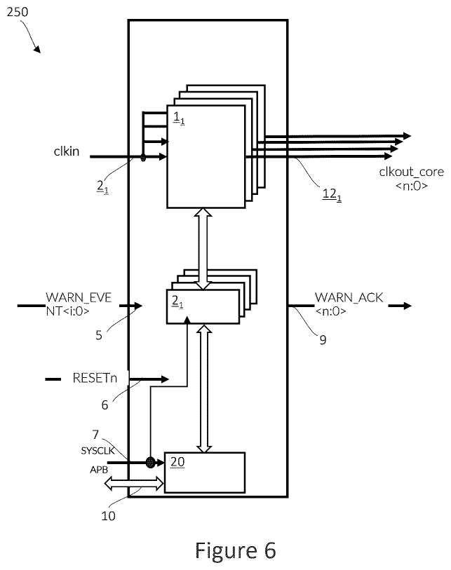

FIG. 6 schematically shows a block diagram of an example system 250 comprising the clock throttler circuitry of FIG. 1 in accordance with the present techniques, which may be provided in a subsystem to control the effective frequency of the clock signal supplied to that subsystem.

The system 100 comprises a plurality of clock throttler circuits 1ₙ, to provide a throttled clock signal to a core of the subsystem.

The system 100 comprises a plurality of mitigation state machines 2ₙ, each to control a corresponding clock throttler circuit, e.g. responsive to an event (e.g. an overcurrent or overtemperature event.

The system 100 also comprises the storage circuitry 20, which in the illustrative example of FIG. 1 comprises a register bank 20 comprising a plurality of registers.

The system 100 comprises various input and outputs to receive/provide signals (e.g. from external hardware and/or software components).

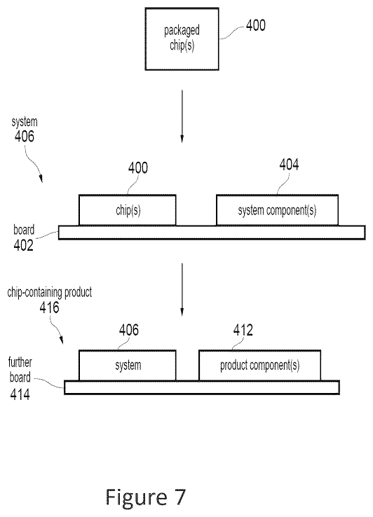

As shown in FIG. 7, one or more packaged chips 400, with the circuitry described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the circuitry described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

As will be appreciated by one skilled in the art, the present technology may be embodied as a method, a circuit or a computer readable medium comprising data and imperatives to cause construction of a circuit. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. Clock throttler circuitry for generating a clock signal, the circuitry comprising:
first selection circuitry to select a first pattern of a plurality of patterns in storage, where each pattern of the plurality of patterns comprises a plurality of bits;
second selection circuitry to sequentially select bits of the first pattern and to provide the selected bits to clock gate circuitry in a successive manner;
where the clock gate circuitry is to receive a clock input signal and to pass or gate pulses of the clock input signal responsive to applying the selected bits to generate a clock output signal.

2. The circuitry of claim 1, further comprising a state machine circuitry to generate a sequence of bit selection signals, each bit selection signal comprising a bit identifier to identify an individual bit of the first pattern.

3. The circuitry of claim 2, where the state machine circuitry is to generate a bit selection signal of the sequence every one or more clock cycles.

4. The circuitry of claim 3, where the second selection circuitry is to select a bit responsive to the bit identifier in each bit selection signal.

5. The circuitry of claim 1, further comprising first storage to store the selected first pattern.

6. The circuitry of claim 5, further comprising second storage to obtain the selected first pattern responsive to an enable signal from the state machine circuitry.

7. The circuitry of claim 6, where the state machine circuitry is to assert the enable signal and generate a final bit selection signal of the sequence in the same clock cycle.

8. The circuitry of claim 1, where each pattern of the plurality of patterns comprises “n” bits, each bit having a first value or a second value.

9. The circuitry of claim 8, where the clock gate circuitry is to pass a pulse of the clock input signal (clkin) responsive to applying a bit having the first value and to gate a pulse of the clock input signal responsive to applying a bit having the second value.

10. The circuitry of claim 8, where each pattern of the plurality of patterns has a different number of bits having the first value.

11. The circuitry of clam 8, where applying the plurality of bits of the first selected pattern at the clock gate circuitry is to control an effective frequency of the clock output signal.

12. The circuitry of claim 1, where each pattern of the plurality of patterns has an associated pattern identifier.

13. The circuitry of claim 12, where the first selection circuitry is to select the first pattern responsive to an identifier signal comprising a pattern identifier for the first pattern.

14. The circuitry of claim 1, where the selected bits of the first pattern are successively applied at the clock gate circuitry to generate the clock output signal.

15. The circuitry of claim 1, where the first selection circuitry is to select a second pattern responsive to an identifier for the second pattern;
where the second selection circuitry is to select bits of the second pattern and to provide the selected bits to the clock gate circuitry;
where the clock gate circuitry is to pass or gate pulses of the clock input signal responsive to applying the selected bits of the second pattern to generate the clock output signal.

16. The control circuitry of claim 1, comprising bypass circuitry to, when enabled, bypass the first and second selection circuitry.

17. The control circuitry of claim 1, further comprising synchronisation circuitry to synchronise one or more external signals to a clock input domain.

18. A method of operating clock throttler circuitry to generate a clock signal, the method comprising:
selecting, using first selection circuitry, a first pattern of a plurality of patterns in storage, where each pattern of the plurality of patterns comprises a plurality of bits;
selecting, sequentially using second selection circuitry, bits of the first pattern responsive to a sequence of bit selection signals;
providing the selected bits to clock gate circuitry in a successive manner;
passing or gating, at the clock gate circuitry, pulses of the clock input signal responsive to applying the selected bits to generate a clock output signal.

19. A system comprising:
the circuitry of claim 1, implemented in at least one packaged chip;
at least one system component; and
a board,
wherein the at least one packaged chip and the at least one system component are assembled on the board.

20. A chip-containing product comprising the system of claim 19 assembled on a further board with at least one other product component.
